(19) United States
(12) Patent Application Publication
(10) Pub. No.: US 2026/0356506 A1
(43) Pub. Date: Nov. 12, 2026

(54) SYNTHETIC APERTURE RADAR SATELLITE DESIGN AND OPERATION

(71) Applicant: ICEYE OY, Espoo (FI)

(72) Inventors: Mikko Laaninen, Helsinki (FI); Jakub Korczyc, Helsinki (FI); Rafal Modrzewski, Helsinki (FI); Martin Neerot, Luxembourg City (LU); Johnny Finnholm, Pedersöre (FI); Touko Haunia, Punkalaidun (FI)

(21) Appl. No.: 18/997,573

(22) PCT Filed: Jul. 17, 2023
(86) PCT No.: PCT/EP2023/069836

§ 371 Date: Jan. 22, 2025

(30) Foreign Application Priority Data
Jul. 22, 2022 (GB) 2210737.9

(51) Int. Cl. B64G 1/66; B64G 1/10; B64G 1/22; B64G 1/24; B64G 1/44; B64G 1/58; G01S 7/03; G01S 13/90; H01Q 1/02; H01Q 1/24; H01Q 3/36; H01Q 9/04; H01Q 21/06

(52) U.S. Cl. CPC B64G 1/66; B64G 1/1035; B64G 1/2222; B64G 1/2429; B64G 1/443; B64G 1/58; G01S 7/03; G01S 13/90; H01Q 1/02; H01Q 1/24; H01Q 3/36; H01Q 9/0414; H01Q 21/065

(57) ABSTRACT

A satellite radar antenna array is formed as a generally planar structure comprising a plurality of panels. Each panel comprises a plurality of antenna transmit/receive modules; each antenna transmit/receive module comprises a stack of planar elements comprising an RF board and an antenna board, and one or more heat sink components for conducting heat from the RF board; and each RF board comprises a plurality of RF front ends. The stack may additionally comprise a power board.

The invention is in the field of satellite design and operation.

### BACKGROUND

Synthetic Aperture Radar (SAR) is a known method of Earth observation from satellites in space. Traditionally, these satellites have been large and expensive and have been limited in number, with only a few of these satellites in space. Because of the complexity and cost involved, SAR satellites have typically been built by governments or by government-supported space agencies.

As shown by the advent of companies such as Space Exploration Technologies Corporation (SpaceX), commercial organizations are becoming more involved in the space sector and are bringing forth new and innovative technologies to make space-missions less expensive and more accessible to both governmental and commercial organizations. The shift is driven largely by private capital rather than governmental funds, and the commercial players in the field are collectively referred to as being part of the “New Space” industry, as opposed to the “Old Space” industry. The shift is making space much more accessible to commercial organizations, through significant reductions in launch cost, for example, thus spurring innovation and new technologies in the field.

Problems for satellite designers include how to build a large constellation of small satellites for Earth observation that can deliver timely data (more frequent revisits than traditional SAR satellites) at a fraction of the cost of traditional SAR Earth imagery.

Satellite design needs to be inexpensive and simple to build, and its imaging capabilities need to be capable of meeting the resolution and precision requirements of typical space missions of this type. In addition, they need to be built small enough to minimize launch costs by taking advantage of the “New Space” commercial launch opportunities that allow small satellites to be launched at a fraction of the cost of traditional satellite launches, for example through the use of “rideshare” launches offered by SpaceX where multiple spacecraft from different organizations (including governments and commercial entities) can be sent into space as part of a single mission.

The smaller satellite size requires a SAR design that is significantly smaller than in traditional satellites and that solves a number of problems associated with small SAR systems, for example achieving an acceptable image quality with a smaller SAR aperture.

Some aspects of satellite design and construction described below solve some of these problems. However, the invention is not limited to solutions to these problems and some embodiments of the invention may solve other problems.

### SUMMARY

This summary is provided to introduce a selection of concepts in a simplified form that are further described below in the detailed description. This summary is not intended to identify key features or essential features of the claimed subject matter, nor is it intended to be used to determine the scope of the claimed subject matter.

In a first aspect there is provided in the following a satellite for operation in orbit around Earth comprising: a propulsion system, an attitude determination and control system “ADCS”, and a radar antenna array; wherein the radar antenna array is formed as a generally planar structure comprising a plurality of panels, each panel comprising a plurality of antenna transmit/receive modules; each antenna transmit/receive module comprises a stack of planar elements comprising an RF board and an antenna board, and one or more heat sink components for conducting heat from the RF board; and each RF board comprises a plurality of RF front ends.

As the following explanation will show, the arrangement of RF front ends in this way, with power components being positioned close to the amplifiers they are supplying, has enabled an increase in power density which has led to an increase in achievable image resolution with a small satellite.

The term “board” is used in the art to refer to a board supporting one or more components such as antenna elements, amplifiers or power supply components. In other words the components are said to be comprised in the board such that the term “board” not only refers to e.g. a substrate but also components which it supports.

A number of the benefits described here are due to the particular construction of the antenna array, which may be supplied separately for use with any suitable propulsion and ADCS, and therefore there is also provided here an antenna array for use with a satellite as described here.

Thus in another aspect there is provided a satellite radar antenna array formed as a generally planar structure comprising a plurality of panels, wherein: each panel comprises a plurality of antenna transmit/receive modules; each antenna transmit/receive module comprises a stack of planar elements comprising an RF board and an antenna board, and one or more heat sink components for conducting heat from the RF board; and each RF board supports a plurality of RF front ends.

The following additional features may be provided in a satellite radar antenna array or a satellite as described here:

Each RF board comprises between 8 and 32 RF front ends, for example 16 front ends. Each front end may comprise a power amplifier, a transmit/receive switch and a low noise amplifier.

The satellite or antenna array may be configured for operation as a phased array. Each RF front end may comprise a digital phase shifter in each of the transmit and receive directions.

The antenna board may support an array of antenna elements, which may comprise patch antenna elements.

Each RF front end may be configured to drive a plurality of antenna elements.

The area of the radar antenna array may be between 1 m² and 5 m² optionally between 1 m² and 3 m².

The radar antenna array may have an aspect ratio between 2 and 24.

The radar antenna array may comprise a row of panels with adjacent panels being pivotable with respect to each other whereby the array may be folded for transport and deployed in space.

An array of solar panels may be provided in a fixed relationship to the radar antenna array.

The solar panels may be arranged in a generally planar arrangement extending in two opposing directions parallel to the extending directions of the radar antenna array with the plane of the solar panels perpendicular to the plane of the plane of the radar array.

The solar panels may be arranged with adjacent panels being pivotable with respect to each other to enable the solar panel array to be folded for transport and deployed in space.

A mass memory may be provided for storage of data acquired by the radar antenna array and a transmitter may be directly connected to the mass memory for downloading of the data.

The stack of planar elements may further comprise a power board. The one or more heatsink elements may comprise a heatsink board in contact with the RF board. The heatsink board may be arranged between a power board and the RF board such that adjacent major surfaces of the heatsink plate, the power board and the RF board are in contact for the conduct of heat. The one or more heatsink elements may comprise one or more structures arranged to conduct heat away from the RF board to the antenna board.

The radar antenna array may be operated at wavelengths between 4-12 GHZ, optionally between 8-12 GHz or between 4-8 Ghz.

The satellite and radar antenna array described in the following are intended to operate as a synthetic aperture radar but may have other applications.

The ADCS is configured for rotating the satellite about an axis parallel to the direction of travel along an orbit. Thus the whole satellite may be manoeuvred, for example as part of an image acquisition operation. This may be in addition to electronic steering achieved by operation of the array as a phased array.

There is further provided in the following a satellite for operation in orbit around Earth comprising: a propulsion system, an attitude determination and control system, a power source comprising one or more solar panels for power, and an active phased array synthetic aperture radar “SAR” antenna; wherein: the SAR antenna has an area less than 5 m², with a peak transmitted power of greater than 1,000 W per meter square or an average transmitted power of greater than 200 W per meter square during imaging.

The phased array SAR antenna may be configured to be folded for transport and deployed once in orbit.

The satellite may have a mass less than 1000 kg, for example less than 843 kg or less than 500 kg or less than 200 kg.

The satellite of any preceding claim wherein the peak transmitted power may be greater than 1000 W per meter square or the average transmitted power is greater than 200 W per meter square during imaging.

The peak transmitted power may in the range of 1000 to 5000 W per meter square or the average transmitted power is in the range of 200-1000 W per meter square.

There is also provided in the following method of operating a satellite according to any preceding claim for obtaining image data comprising limiting the time per orbit during which the radar antenna array is switched on to avoid overheating of the radar antenna array.

For example the acquisition of image data may be restricted to 2-4%, e.g. 3%, of the duration of the satellite orbit.

Features of different aspects and embodiments of the invention may be combined as appropriate, as would be apparent to a skilled person, and may be combined with any of the aspects of the invention.

### BRIEF DESCRIPTION OF THE DRAWINGS

Embodiments of the invention will be described, by way of example only and with reference to the following drawings, in which:

FIG. 1 is a perspective view of a satellite;

FIG. 2 is an alternative perspective view of the satellite shown in FIG. 1;

FIG. 3 is a perspective view of the satellite of FIGS. 1 and 2 configured for transport;

FIG. 4 is a schematic diagram of part of an example payload that may be carried by the satellite of FIGS. 2 and 3;

FIG. 5 is a schematic diagram of a transmit/receive module stack;

FIG. 6 is a schematic diagram of an example front end and associated antenna patches;

FIG. 7 is an enlarged view of part of the radar antenna array shown in FIG. 2;

FIG. 8 is a perspective view of an assembly comprising an RF board and power board, that may be comprised in a transmit/receive module;

FIG. 9 is an enlarged partial elevation view of the satellite from the direction z of FIG. 2;

FIG. 10 is a schematic diagram illustrating a possible arrangement of satellite electronics components;

FIG. 11 shows a possible configuration of the components shown in FIG. 10.

Common reference numerals are used throughout the figures to indicate similar features.

### DETAILED DESCRIPTION

Embodiments of satellite design and operation are described below by way of example only. These examples represent the best ways of putting the invention into practice that are currently known to the applicant although they are not the only ways in which this could be achieved.

The present disclosure is concerned with the design and operation of small satellites.

Various classes of satellites are currently in orbit around the earth, generally defined by ranges of weights, although the boundaries between the classes are somewhat fluid and arbitrary. These include cube satellites, micro satellites, and others. One constraint that differentiates one class of satellites from another is the ability for it to be launched. Therefore it is desirable for the weight of a satellite to be below a particular maximum to enable it to be launched from a vehicle such as SpaceX's Falcon 9 rockets. For example, SpaceX offers rideshare launches where multiple satellites can be launched into different orbits as part of a single mission. These rideshare programs offer a lower-cost alternative to getting satellites into orbit compared to traditional customized missions. Part of the rideshare program involves standardized mounting set-ups for payloads. For example, SpaceX offers on their rideshare program a 0.381 m (15 inch) “Exo-port” with a maximum mass of 454 kg (1,000 lb) or a 0.610 m (24 inch) port with a maximum mass of 830 kg. Smaller satellites (e.g., with a maximum mass of 227 kg or less) can also be accommodated. Sometimes, multiple satellites can be launched on a single Exo-port, as long as the overall weight and volume constraints for the rocket and the rocket fairing are within the requirements. The term “small satellites” is used here to refer to the kinds of satellite that can be launched on the current commercial launches and is generally but not necessarily limited to those weighing less than 1000 Kg.

The present disclosure is therefore concerned with the design and operation of satellites with a weight below 830 kg, below 454 kg, or below 227 kg (to allow for two satellites to be launched using one port).

Other launch providers are also possible, such as on the Vega rocket developed by Airanespace, the Italian Space Agency, and the European Space Agency. Vega's rideshare service uses the Small Spacecraft Mission Service and is designed to launch small payloads for scientific and Earth observation missions. Requirements and interface parameters for the various launch providers are similar, although not necessarily identical.

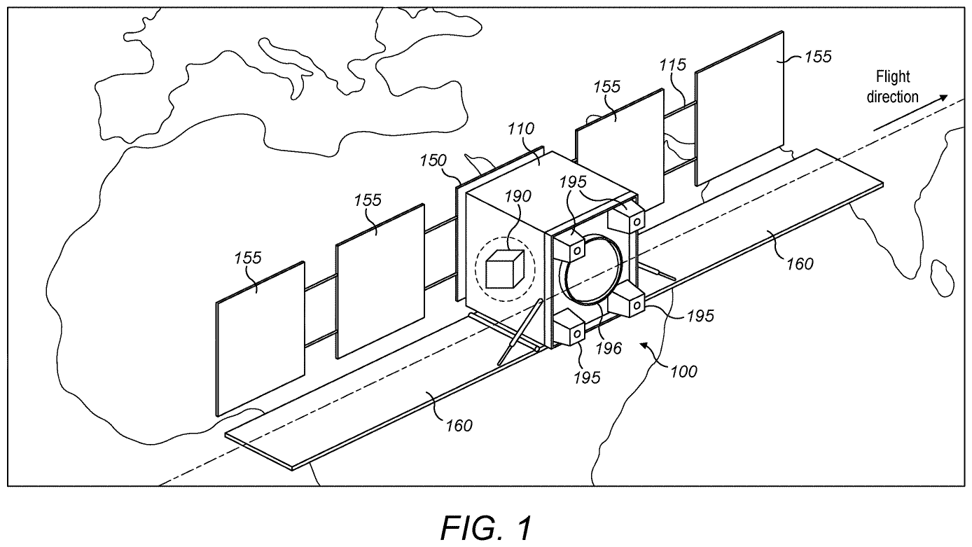

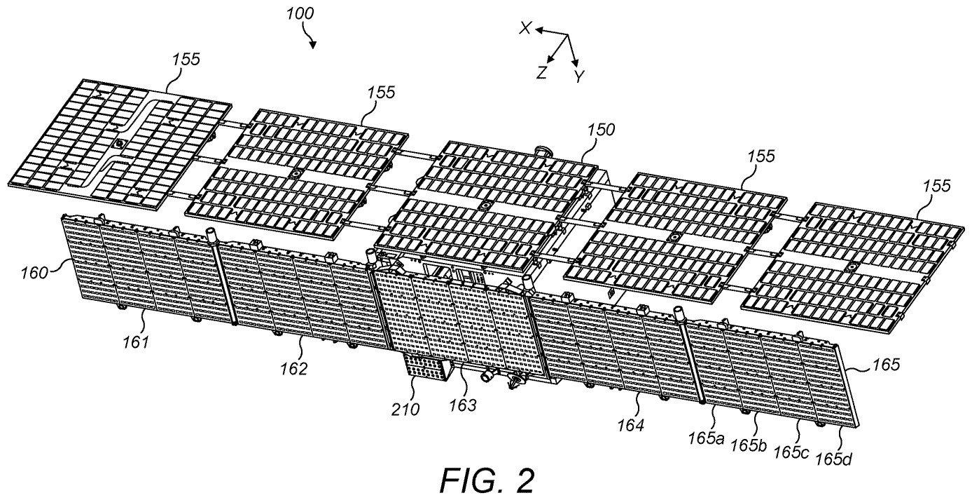

FIGS. 1 and 2 are different perspective views of a satellite 100. The basic components of a satellite similar to that of FIGS. 1 and 2 are described in our earlier patent application WO2022079168A1. A small satellite according to an example comprises a propulsion system and an attitude determination and control system “ADCS” as is known in the art. Notably in the satellite designs discussed here the ADCS may be controlled to manoeuvre the entire satellite to achieve desired positioning and orientations (e.g., look angles) during imaging operations.

The satellite 100 is also provided with a propulsion system for manoeuvring the satellite with a generated thrust, described in more detail in WO2022079168A1.

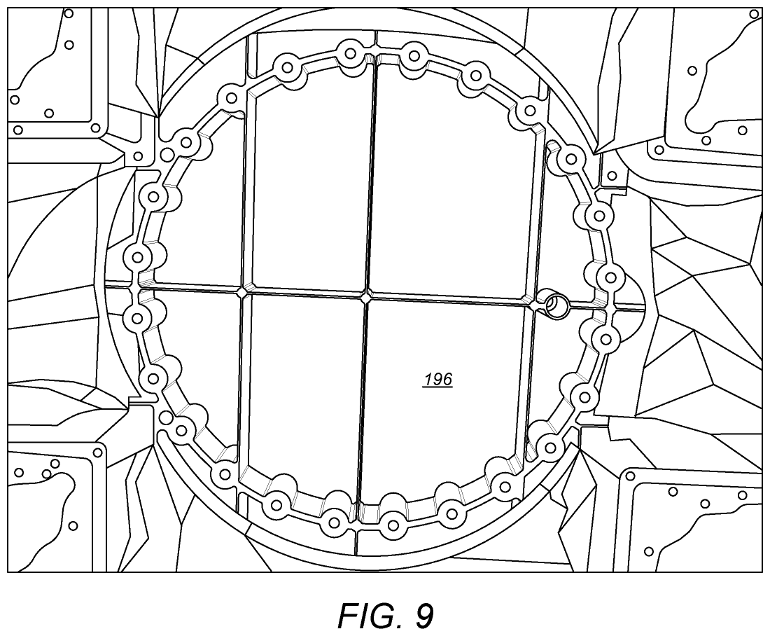

The satellite comprises a body or bus 110, housing or supporting components including the ADCS 190 and the propulsion system, shown in FIG. 1 to comprise four thrusters 195. The body 110 is also referred to in the art as a “bus” since it may house or support bus components. Bus 110 may additionally house one or more batteries. Bus 110 may be partially enclosed, for example to house and protect components. A housing may provide surfaces on which components may be mounted. In the satellite of FIGS. 1 and 2 an array of solar panels is provided comprising solar panel 150 mounted on one rectangular surface of the bus 110 and additional solar panels 155 attached to solar panel 150 by struts 115. The illustrated satellite has a total of 5 solar panels 150, 155 forming a solar array described further below. In the illustrated example the solar array has 5 rectangular panels. The solar panels are arranged in a row with adjacent panels being pivotable with respect to each other whereby the solar panel array may be folded for transport and then deployed once in space. In the example of FIGS. 1 and 2, panels 155 are deployable and panel 150 is mounted on the bus 110. In an example, each panel contains 112 solar cells placed on the front side of the satellite (−Y face, see FIG. 2), connected to the satellite's battery, and provides up to approx. 90W of power when directly pointing to the Sun. The mean orbital power during nominal operations may be around 350 Wh. A radiator panel 196, described further with reference to FIG. 9, is used as both a radiator for thermal management within the satellite and in this example for attaching the satellite 100 to a rocket during launch.

Other components comprised in the satellite may be provided in order for the satellite to perform a mission and these are known as the “payload”.

In an example the payload is an earth observation system for imaging the Earth's surface know as a synthetic aperture radar system, or SAR system. Such a payload operates by sending radar signals from a synthetic aperture radar antenna to the Earth and listening for the returning echoes. By recording the echoes, an image of the Earth's surface can be constructed from data including the length of time taken for the echo to return (indicating location), the amplitude of the radar return, and the phase information that is included within the radar signal. Further location information is obtained from the frequency of the returned signal which is shifted due to the Doppler effect as a result of the relative motion of the satellite to the earth.

The field of synthetic aperture radar is well known in the art, and the first civilian SAR satellite was launched in 1978. However, SAR satellites are traditionally quite large (>1000 kg), complex, and very expensive to design, build, and launch. They traditionally required dedicated launches to get to space and were thus too expensive for commercial non-governmental applications. A number of challenges exist for implementing SAR in smaller satellites, which can then be launched by the new commercial launch providers at a significantly reduced cost.

The example satellite 100 shown in the figures comprises a radar antenna array 160 in the form of a generally planar structure extending from the bus 110 in two opposing directions to provide two “wings”. The “flight” direction of the satellite is generally parallel to these opposing directions, e.g. parallel to the longitudinal extent of the antenna array and in this example the longitudinal extent of the solar panel array. The radar antenna array 160 comprises antenna elements and associated electronic circuitry described further below. The radar antenna array 160 is shown to be mounted on or adjacent to a rectangular surface of the bus 110. The radar antenna array 160 may be formed in sections, referred to here as panels, so as to be folded for transport on Earth and into space and unfolded when deployed, in a similar way to the solar panels. The solar panel struts 115 may be constructed so that the solar panels 155 may be transported close to the body 110 and positioned away from the body as illustrated on deployment of the satellite. The body 110 and structure of the radar antenna array 160 may be collectively referred to as the spacecraft frame.

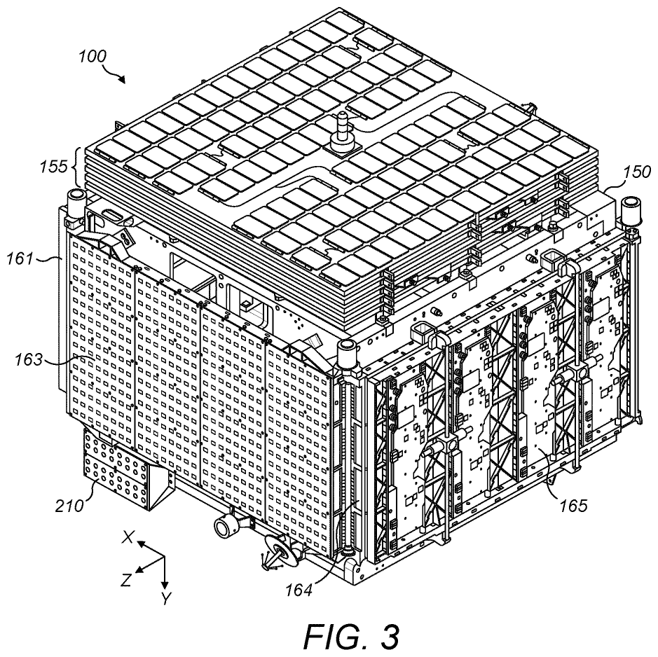

FIG. 3 is a perspective view of the satellite of FIGS. 1 and 2 with both the radar antenna array 160 and the array of solar panels folded in against the bus 110 to minimize the volume of the satellite 100 during transport and launch. Once the satellite has been launched into space and separates from the rocket, instructions are given for it to deploy the solar panels and the radar antenna array, for example from a ground station, also known in the art as a ground segment, not illustrated. It does this by unfolding the solar panel array and the radar antenna array 160 until they reach the configuration shown in FIG. 2.

The designs described here are not limited to an arrangement comprising a central body or bus and other configurations of ADCS and thrusters are possible.

In the deployed configuration shown in FIGS. 1 and 2 the bus 110 is cuboidal. Referring to FIG. 1, the solar panels 150, 155 are arranged in a generally planar arrangement extending in two opposing directions parallel to the extending directions of the radar antenna array 160, with the plane of the solar panels perpendicular to the plane of the plane of the radar array 160. The two planes may be parallel to respective sides of the cuboidal body. With this configuration, the plane of the radar antenna array may face the Earth and the plane of the solar panels may face the sun. Notably the solar panels, once deployed, may be in a fixed relationship to the radar antenna array 160, in contrast to known designs in which the solar panels are rotatable or pivotable with respect to the satellite body and hence the radar antenna array. The lack of requirement for the solar panels to be manoeuvrable contributes to reducing the overall weight of the satellite.

The radar antenna array 160 comprises a plurality of antenna elements mounted on its major surface facing away from the bus 110. Other components may be comprised in the radar as is known in the art including power distribution components and amplifiers, examples of which are described in our earlier patent application WO2020094872A1 and discussed further below. The totality of the antenna elements constitutes what is generally referred to as the satellite antenna. This constitutes the SAR antenna, i.e., the antenna via which SAR signals are transmitted and received.

The illustrated satellite 100 comprises a separate antenna 210, referred to as the downlink antenna, for communication with a ground station and/or other space or aircraft. Thus in this example satellite the antenna array is used principally for the transmission and reception of SAR signals. Data exchanged via the antenna 210 may comprise raw or processed SAR data downloaded to earth, instructions for operation of the satellite and other data as will be familiar to those skilled in the art. The downlink antenna 210 may have a smaller aperture than the antenna array 160. In addition to the downlink antenna, the illustrated satellite 100 may also comprise one or more additional antennas for telemetry to the ground. These telemetry antennas are typically smaller than the SAR antenna or the downlink antenna 210.

Referring to FIG. 2, the antenna elements may be patch antennas arranged in a common plane. The total area of the antenna elements, i.e., the total area of the radar antenna array 160 in the satellite of FIGS. 1 and 2, defines the antenna aperture. In the example illustrated in FIG. 1, the aperture has an area of 3.2 m×0.4 m=1.28 m² and the aspect ratio in the flight direction is 16, i.e., the length in the flight direction is 16 times the width. In another example, the width of the antenna array is increased up to 0.8 m (2.56 m²) while still using a similar design and modular construction. In this case the aspect ratio is 4. In general, the aperture may have any size between about 1 m² and about 3 m², or between 0.5 m² and about 5 m², and the aspect ratio may be between 2 and 24. The antenna is shown in FIG. 1 to be divided into 5 panels 161, 162, 163, 164, 165.

The antenna elements may be operated as a phased array to steer the radar beam in either or both of azimuth and elevation. The steering may be active, as described further below. The term “active” is used in this context to refer to amplification and optionally also power being supplied to antenna elements individually or in groups rather than collectively to the whole antenna array.

The radar antenna array 160 is comprised in what is known as the satellite “payload”. The term “payload” generally refers to instrumentation carried by the satellite for performing the satellite's intended function, such as Earth observation. Thus, anything other than the satellite propulsion system, attitude determination and control system “ADCS” and other basic requirements for the satellite to operate may be considered to be part of the payload. Thus, the radar antenna array 160 may be comprised in the payload and some components housed in the bus 110 may be comprised in the payload.

In one example the radar antenna array may comprise a single-channel, VV polarized phased array Synthetic Aperture Radar. Three main imaging modes are known in SAR imaging: Strip, Spot and Scan. In the satellite illustrated in FIG. 1 this has been achieved using phased array technology.

There has been a prejudice in the art against the use of active phased array SAR technology in small satellites, for example satellites of the kind discussed above that may be launched by commercial providers. In some circles this was not thought to be possible. Other designs such as those using SAR reflectors and also those using waveguides instead of active phased arrays are being actively pursued. The present inventors have successfully deployed active phased array technology in a small satellite and achieved outstanding image resolution, through a range of developments described further here. For example, slant range resolution in the cross-track direction of 0.5 m has been achieved, providing (depending on the look angle) resolution of approximately 1 m. Even higher resolutions could be potentially achieved. Resolutions (e.g., down to 25 cm) could also be achieved in the azimuth direction.

One problem with using a phased array SAR with a small satellite is thermal management. This is particularly important in the case of the satellite described here which has a relatively small SAR antenna array. The traditional expectation of a small satellite is that a high-resolution image is not achievable using an active phased array SAR because the small SAR antenna is not able to transmit sufficient power to create a good quality image. In general, image quality is a function of total transmitted power, which is related to the size of the antenna and the power density being transmitted by the antenna. In the example satellite described here, high quality images are made possible by designing the satellite to operate at higher power densities than previously thought achievable in order to achieve good imaging performance.

An important feature of the satellite disclosed here is the close placement of amplifiers to the antenna elements, for example in the wings of the satellite rather than in the main bus. This reduces signal losses, helps with thermal management, and allows for higher transmitted power densities. According to an example, antenna elements comprised in the antenna array 160 have dedicated amplification located close to the antenna elements. This may be in a modular arrangement, so that the amplification and optionally associated power supply components are distributed across the radar antenna array 160. In the modular arrangement, each panel 161-165 may comprise a module, or each panel may comprise multiple modules, with separate amplification being provided for each module. This distributed amplification arrangement may also provide a high degree of resiliency against component failure, which might otherwise occur with a centralized amplification system. In a specific example each module comprises multiple RF front ends and each front end is connected to one or more antenna elements, for example patch antenna elements. Each front end may comprise a power amplifier and low noise amplifier. In the illustrated example, each front end powers 8 antenna elements using a 20 Watt power amplifier chip from Qorvo of Greensboro, North Carolina, USA. Other RF power amplifiers with different wattages powering different groupings of antenna elements are also possible depending on the design of the particular antenna. For example, lower wattage (e.g., 5 W) power amplifiers can be used with four times larger antenna to achieve the same transmitted power. Similarly, a higher wattage power amplifier (e.g., 30 W) could be used with a smaller antenna to achieve the same transmitted power as long as suitable thermal management steps are taken. In an example, power amplifiers between 5 and 30 W can be used.

The ability to provide power to groups of individual antenna elements or groups of antenna elements rather than collectively to the whole antenna array enables the phased array to be actively controlled.

Features of an example satellite as shown in FIGS. 1 and 2 and its payload are listed in table 1.

TABLE 1

| Aperture | 3.2 m × 0.4 m | |
|---|---|---|
| Frequency band | 9500-9800 | MHz |
| Number of front ends | 320 | |
| Pulse Repetition Frequency | 2-10 | KHz |
| Peak radiated power (imaging) | 3200 | W |
| Average radiated power (imaging) | 640 | W |
| Peak power density (imaging) | 2500 | W/m² |
| Average power density (imaging) | 500 | W/m² |

In the above example the frequency band is X-band (8 GHZ-12 GHZ). Some of the designs discussed here may operate in C-band, with a frequency in the range of 4-8 GHZ.

The overall satellite design including the payload is different in many respects from existing satellites and has been shown to achieve outstanding performance. Nevertheless, the satellite may be constructed very cost effectively. For example, the payload may be designed using commercial off-the-shelf components and standard PCB manufacturing processes. The small size and relative simplicity of the satellite also is an important factor in reducing manufacturing and launch costs.

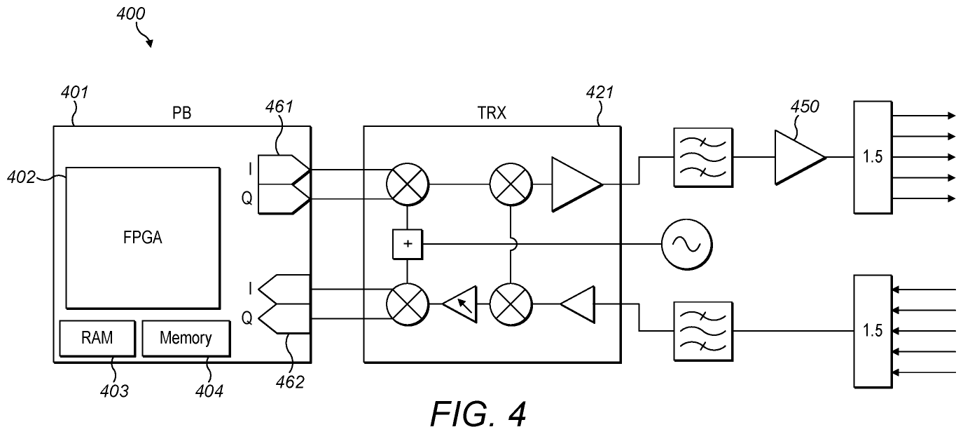

A schematic block diagram of part of an example payload 400 is shown in FIG. 4. The illustrated payload has at its heart a unit called the Processing Board 401, which contains an application processor that could be a Field Programmable Gate Array “FPGA” 402, buffer Random Access Memory “RAM” 403 and flash mass storage 404 in FIG. 4. The FPGA 402 can store up to 100 individual waveforms for imaging. Each waveform may be generated in a ground segment for a particular imaging mode and geometry, e.g., slant angle, and uploaded to the satellite.

The waveforms may be fed into differential digital to analog convertors “DACs” 461 that provide separate I and Q signals at baseband. The signals are transmitted from the satellite to a target, for example a target to be imaged, via transceiver 421 and amplifier 450. Echo signals are then received as a result of the transmitted signals being reflected from the target. At reception onboard the satellite, received signals are received via transceiver 421, and converted to digital using analog to digital convertors “ADCs” 462. The samples coming from the ADCs are passed through a decimation filter and compression, not shown. Because of the high data rate, the data is stored in a RAM buffer before writing to flash memory for later downlink.

The baseband signals are modulated into an intermediate frequency at a transceiver 421, and then upconverted to RF. After a further amplification stage 450 the signal is divided into five outputs that feed the radar panels 161-165. On the receiver side, the same 5-way splitter design is used in a combiner mode and the signal fed through low noise amplifiers “LNAs” and down conversion, filtered and amplified at an intermediate frequency IF before demodulation into I and Q baseband components. The receiver gain may be digitally adjustable at IF, although in practice this feature sees little use since the ADC can accept a wide dynamic range.

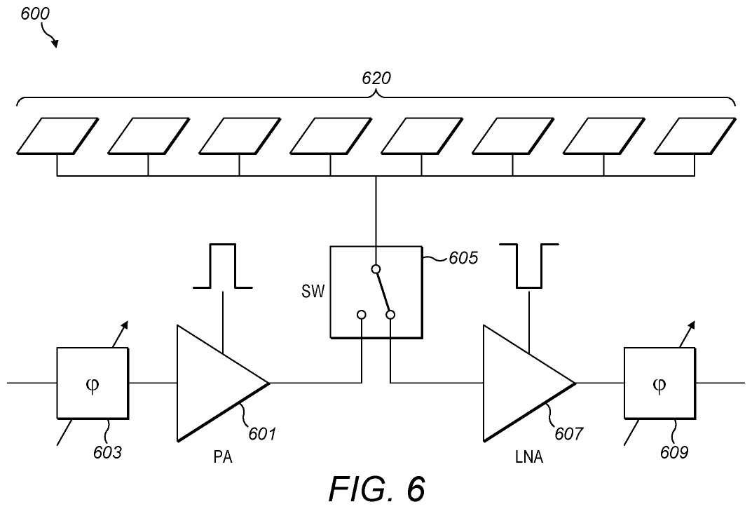

The components shown in FIG. 4 may be housed in the bus 110. In the example configuration of FIGS. 1 and 2 the radar antenna array 160 is divided into five panels 161-165. These panels may contain four transmit/receive “T/R” modules each for a total of twenty modules. Each module may comprise multiple RF front ends as described further with reference to FIG. 6. The central panel 163 may be attached to the spacecraft bus 110 and the deployable panels 161, 162, 164, 165, two on each side, may be stowed against the bus 110 for launch, as shown in FIG. 3. One set of T/R modules 165a-165d is indicated in FIG. 2.

A beamforming network to transmit signals from the bus 110 to the panels or modules may comprise a phase matched coaxial cable harness and microstrip dividers to split the signal between modules. Calibration of the residual phase mismatch of the harness may be achieved in anechoic chamber tests using a custom-built linear scanner.

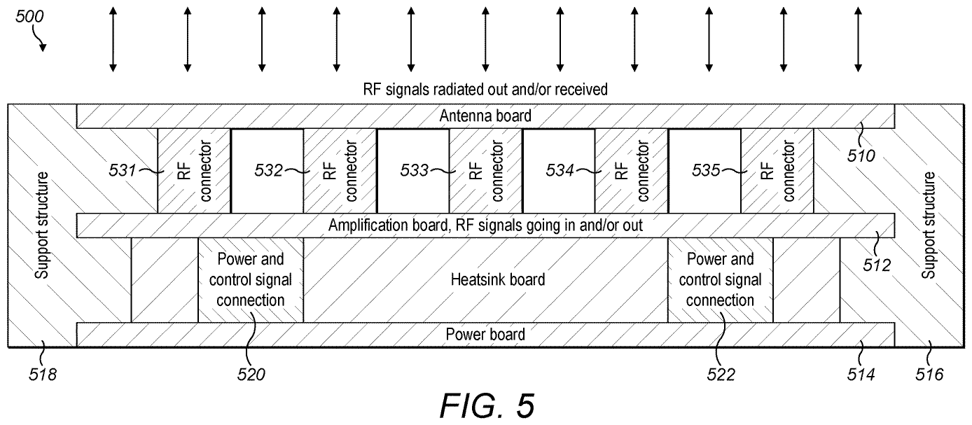

Each T/R module 165a-165d, which may be identical to all of the other modules, may be made up of a stack, e.g., a set of planar elements arranged in parallel one above the other, for example as shown in FIG. 5. Here the planar elements comprise a power board 514, heatsink board 513, RF board 512 and antenna board 510. The heatsink board 513 is an example of one or more heatsink elements that may be provided to absorb and conduct heat away, primarily from the power and RF boards. Also provided is a support structure 516, 518 supporting the edges of the respective boards with respect to each other which may also serve as a heatsink element for conducting heat away from the RF board, and possibly also the power board, to the antenna board. As noted above, an important aspect of the design of the satellite described here is the placement of the amplification close to the antenna elements. This achieves significant advantages over prior designs. Further advantages may be achieved by additionally placing power components close to the amplifiers being provided with power, rather than for example at the bus 110.

Heat is generated during operation of the radar antenna array 160 to collect imaging data. With the structure shown in FIG. 5, heat may be conducted from the amplifier board 512 via the heatsink board 513 and/or the support structure 516, 518 to the antenna board 510 from where it may be radiated out. Heat may also be conducted from the RF board to the antenna board via the RF connectors. The opposite surface of the power board 514 may be pointing at the sun while the antenna array is directed towards Earth and therefore it is desirable for heat to be radiated away from the satellite via the antenna board rather than the power board. However, at times the back of the power boards may be pointing towards space at which point they can also be useful for radiating away heat. The opposite surface of four power boards 514 can be seen in FIG. 3 on the backside of antenna module 165 shown in FIG. 3 in its stowed position.

The power board 514 may support power supply components such as regulators and switches to bias the RF components on the RF board, and optionally one or more functions such as but not limited to telemetry collection and control of the electronic beam steering.

The RF board 512 may support a plurality e.g., sixteen of identical frontends as shown in FIG. 6. Further, the RF board may support a driver amplifier and separate divider/combiner networks for the transmit and receive sides. An example front end 600 and associated antenna patches is illustrated schematically in FIG. 6.

The heatsink board or plate 513 may comprise a plate of a suitable material with good thermal conductivity such as a metal, e.g., aluminium. The heat sink plate 513 is sandwiched between the power board 514 and the RF board 512 so that the adjacent major surfaces of the heatsink plate 513, the power board 514 and the RF board 512 are in contact to facilitate the conduction of heat away from the RF board. Holes are provided in the heat sink board to allow for power and control signal connections between the power board and the RF board. In an example, a suitable thickness for the heat sink board is 0.5-3 mm.

Components mounted on the RF board 512 are shown to be connected to antenna elements supported on the antenna board by RF connectors 531-535, which may be co-axial snap-on connectors. Only five connectors are shown in this schematic diagram. In practice the number of connectors may correspond to the number of RF front ends.

Components of a suitable front end 600 are shown in FIG. 6 connected to an array 620 of antenna patches. The components of 16 front ends 600 may be mounted on a single RF board 512. Each front-end may comprise, on the transmitting side a 20W class solid state power amplifier “PA” 601 preceded by a digital phase shifter 603, followed by a T/R switch 605, and on the receiving side a front-end LNA 607 and digital phase shifter 609. The amplifiers 601 and 607 are switched on and off to follow the transmitted waveform. The antenna 620 is shown to be a patch array with eight patches being fed from a single front end, connected to the RF board for example by connectors 531-535. The patch array 620 is a sub-array of the radar antenna array 160.

The number of antenna elements driven by a single front end may depend on the particular geometry chosen for the radar antenna array, for example the number and size or panels and modules. It is convenient but not essential for this number to be a power of 2 such as 4, 8, 16, 32 etc.

Thus it will be appreciated that the design uses a single board for multiple transmit receive modules. In this example there are 16 PAs, 16 LNAs, transmit/receive switches and other components on the same RF board 512. The provision of multiple front ends on the same board is advantageous because it allows for high power to be transmitted from the antenna in both an energy efficient and space-efficient manner. In general the number of front ends contained on a single RF board is only limited by mechanical and thermal considerations.

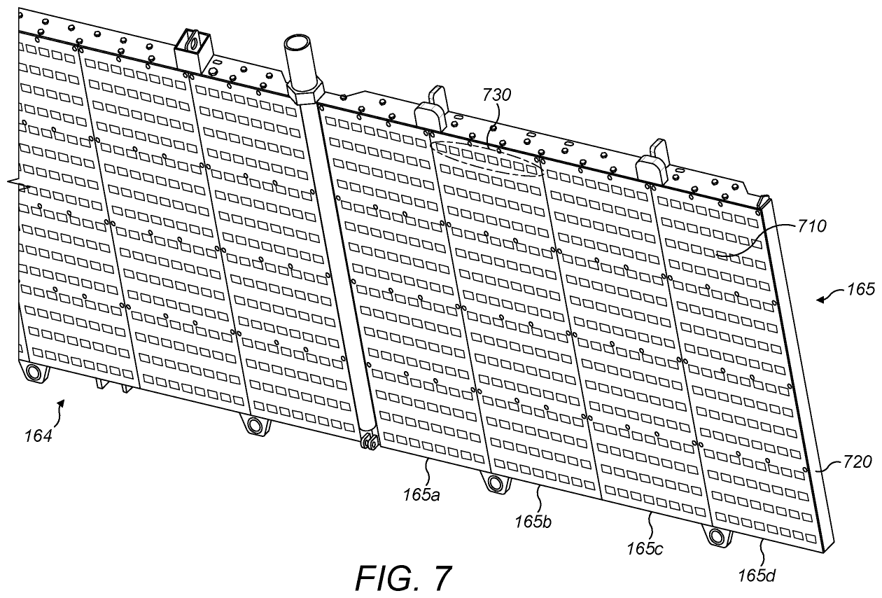

FIG. 7 is an enlarged view of part of the radar antenna array of FIG. 2 showing antenna panel 165 with four modules 165a, 165b, 165c, and 165d, and part of antenna panel 164. Each module comprises. sixteen rows of antenna patches with eight antenna patches per row. One antenna patch is indicated by numeral 710 and numeral 730 denotes a row or antenna sub-array. Sixteen front ends on the RF board behind the antenna board, not visible in FIG. 7, drive each antenna module, with each front end driving one row of eight antenna patches. Each antenna patch may be said to be an element of the SAR antenna or radar antenna array 160.

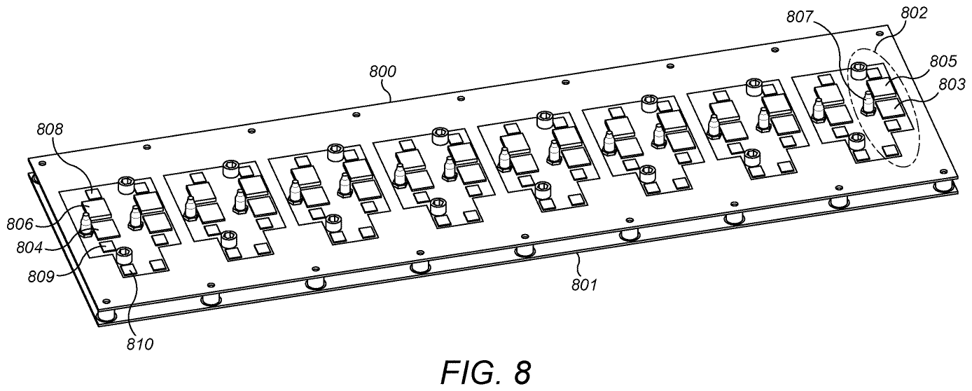

FIG. 8 is a perspective view of an assembly comprising an RF board 800 and power board 810, that may be comprised in a transmit/receive module. The RF board 800 and power board 801 are shown in FIG. 8 and may be separated by support structures that can conduct heat away from the RF board 800 and also act as heatsinks. A heat sink plate or board (not shown) can also or alternatively be sandwiched between the RF board 800 and power board 810.

The components on the top surface of the RF board 800 are visible in FIG. 8. The oval 802 to the right of RF board 800 indicates one RF front end as shown in FIG. 6, and numeral 807 denotes a coaxial connector. In an example, each RF front end uses the same components and each front end drives 8 antenna elements. For example, components 805 and 806 are the power amplifiers for two RF front ends respectively, corresponding to PA 601 in FIG. 6. Similarly, components 803 and 804 are transmit and receive RF switches corresponding to SW 605. Component 809 is the low-noise amplifier, corresponding to LNA 607. Components 808 and 810 are phase shifters corresponding to phase shifters 603 and 609 in FIG. 6.

The arrangement of components described in the foregoing has been used to achieve a greater power density than was previously thought possible for a SAR satellite. The peak radiated power from the 3.2×0.4 m antenna is 3.2 KW which is equivalent to a peak power density of 2,500 W per square meter. This power is transmitted during the transmit phase while imaging. The antenna is transmitting about 20% of the time and receiving for 80% of the time. Thus, average power density is 500 W/m² during imaging. In general, some of the benefits of the designs described here can be achieved with peak power densities greater than 1000 W/m² and/or average power densities greater than 200 W/m².

The same design could be used to achieve a doubling of the total peak power to 5,000 W by, for example, doubling the area of the SAR antenna while maintaining the same peak and average power density. This can easily be done using the same modular components used in the example satellite described in this disclosure. Alternatively, the total power transmitted could also be doubled by maintaining the same antenna size and doubling the peak power density to 5000 W/m² and the average power density to 1000 W/m², with appropriate thermal management. In an example, the range of peak transmitted power density and average transmitted power density for a small satellite that can achieve high image resolution is 1000 W/m²-5000 W/m² for peak transmitted power and 200 W/m² to 1000 W/m² for average transmitted power. Other ranges may be possible. The total transmitted power is limited by the size of the SAR antenna that can be used on a small satellite, and ability of the design to handle the heat generated at higher power densities, as described herein.

The entire payload may be configured from an on-board computer housed in the bus 110 using a differential asynchronous data bus, which may also be used to collect telemetry from each front end. Additionally, there may be two global synchronous signals generated by the processing board which follow the RF waveform: one to trigger switching between TX and RX mode on the T/R modules for each pulse, and another to trigger beam switching, for example in the scan mode of operation.

In scan mode, the SAR radar beam is steered in both range and azimuth. To achieve high speed synchronous beam switching, the steering angle matrix may be broadcast to the T/R modules before imaging and the phase shifter steering vectors pre-computed for each beam. These may then be loaded sequentially from a look-up table for every beam steering trigger pulse.

The available electronic steering angles may be limited by the fact that the spacing of the antenna elements is approximately 0.8λ in range and 5.2λ in azimuth, depending on the exact wavelength λ. Therefore, large angle electronic steering may cause grating lobes to appear. This may be avoided to some extent by a combination of mechanical steering and electronic steering, which may be achieved using the ADCS, to manoeuvre the whole satellite, particularly in the case of a small satellite. In other words, rather than manoeuvring an antenna with respect to the satellite body, which might be feasible in a very large satellite, the whole satellite may be manoeuvred to orient the antenna with respect to the earth. Thus in Strip and Scan modes the entire satellite may be manoeuvred on the roll axis, e.g., rotated about an axis parallel to the X direction in FIG. 2 to point the antenna at the appropriate look angle, while in Spot mode the manoeuvring may be on all three axes to maintain pointing at a particular spot on Earth and also to maintain the local V polarisation of the radar beam in the target area.

Downloading of the payload data may be achieved through a primary X-band transmitter directly connected to the mass memory 404 of the processing board 401 in FIG. 4. Speeds up to 500 Mbits/s have been demonstrated using 8-phase shift keying “PSK” modulation. The transmit power is 4W through a medium gain patch antenna, realised using the same technology as the radar antennas. A redundant, secondary X-band transmitter may be provided for back up purposes.

Constructing a small SAR payload brings many constraints and forces a number of trade-offs. The main challenge for image quality is the small aperture. To achieve reasonable sensitivity, a relatively high pulse power may be used which compensates for the reduced antenna gain. The resulting high power density provides challenges for thermal management, as previously described. Additional consequences of having a small aperture are increased ambiguities in both range and azimuth that degrade the image quality. To reduce these ambiguities, numerous innovative methods to suppress them in processing can be employed, such as those described by Doğan, et al. “Experimental Demonstration of a Novel End-to-End SAR Range Ambiguity Suppression Method” 2022 IEEE Radar Conference (RadarConf22), 2022, pp. 1-6, doi: 10.1109/RadarConf2248738.2022.9764267 and, Radius, et al., “Phase Variant Analysis Algorithm for Azimuth Ambiguity Detection” 2022 IEEE Radar Conference (RadarConf22), 2022, pp. 1-4, doi 10.1109/RadarConf2248738.2022.9764162.

The high transmit power brings with it challenges for power system design as well as for thermal management. The possible solar panel area of small satellites is limiting factor on the power system design and how much power is available to run the payload. As shown in FIGS. 2 and 3, one way to increase the solar panel area and hence the power available to a small satellite is to have deployable solar panels such that they are folded up for transport and for launch into space and unfolded once the satellite has reached orbit. In an example the panels contain 112 solar cells placed on the surface facing away from the bus 110 and in a generally planar arrangement extending in two opposing directions parallel to the extending directions of the radar antenna array with the plane of the solar panels perpendicular to the plane of the plane of the radar array. Each panel provides up to approx. 90W of power when directly pointing to the Sun. The mean orbital power during nominal operations averages around 350 Wh.

Since the solar panels cannot always be pointing towards the sun (e.g., when the satellite is in the shadow of the Earth), any limitations on the solar panel area may be at least partially compensated for by using a battery to accumulate and store energy between image acquisitions. An oversized battery may be used that also allows for operation of the battery in a manner that maximizes its lifetime, for example by never discharging it below 60% and never fully charging it. For example, the battery may comprise an array of modules, e.g. 20 modules, connected in parallel to deliver approximately 33 Volts and be capable of storing approximately 850 Wh. These may be each composed of 8 Lithium-Ion battery cells in series. This is capable of supplying the constant voltage for nominal operations and withstanding the higher load when transmitting with SAR in imaging mode. The battery array may be charged directly from the solar panels and may provide power to a power conditioning module, not shown, for further distribution. The battery array may be housed in the bus 110.

The thermal management at the panels of the radar antenna array may be passive, e.g., not requiring powered components, where the heat from the power amplifiers on the RF board is sunk into the antenna structure, for example via the heatsink board and then conducted to the antenna board to be radiated away. In the satellite illustrated, the thermal management of the antenna array is separated from the thermal management of the components within the bus.

The thermal management of the satellite may be aided by providing one or more radiative surfaces arranged to emit heat accumulated at the satellite into space. For the wings, the surface of the antenna array is also used for radiating the heat away that is generated by the distributed power amplification system while imaging. For components located in the bus, a radiative surface may be provided on the satellite bus 110 to radiate away heat generated in the bus. The radiative surface may comprise any suitable material known in the art, for example a polyvinyl fluoride film.

FIG. 9 is an enlarged partial elevation view of the satellite from the direction −y of FIG. 2 (i.e., viewing the satellite from the back of the bus and of the solar panels) showing the detail for an example of the radiative panel 196 shown in FIG. 1. FIG. 9 shows a radiative surface provided on a radiator panel 196 positioned on a surface of the bus. In this example the radiative surface is on a surface opposite to the solar panels, so that the radiative surface faces in the opposite direction to outward facing surfaces of the solar panels so that it can in general be pointed away from the sun as much as possible. It will be appreciated that this design could be used in an arrangement with only one solar panel.

In the example of FIGS. 1, 2 and 9 panel 196 comprises a radiative surface located on the same surface of the bus as one or more thrusters. In an example, the radiator panel may have a generally circular shape, although it is not limited to being circular and other shapes are possible.

The panel 196 may comprise a structural panel forming part of the existing structure of the satellite body 110, as shown in FIG. 9. Here the panel 196 has a substantially round shape, and a plurality of mounting holes around its outer circumference. Thus, the radiative panel may be an integral part of one side of the satellite bus 110. In an example, the radiative panel can even be part of the structure that attaches the satellite to a release mechanism in a rocket as it is being launched into space (hence the mounting holes). The radiative panel can be made of aluminium which has a rather high coefficient of thermal conductivity. Thus, the temperature is (relatively) uniform on the panel and heat may be conducted from one or more component(s) to require cooling to the radiative panel in a first position and from the radiative panel to one or more component(s) that require heating in a second position. This is particularly advantageous for small spacecraft due to strict mass constraints. Heat is transferred to and from the structure through emission and absorption on the reverse side of the radiative surface as well as through heat conduction through structural members, not shown, connecting the radiative surface to other parts of the spacecraft. The satellite may be manoeuvred between the first and second positions using the ADCS in order to manage the transfer of heat to and from the structure.

The decision to use only passive thermal management can lead to a limitation on the amount of time that the payload can be on since if it is on too long overheating may occur. This in turn leads to a limitation on the number of images or amount of image data that can be acquired during a single orbit. The limitation on how long the payload can be on and hence the amount of image data that can be acquired in a single orbit leads to a necessary trade-off of small SAR, meaning a limitation on the number and duration of images that can be acquired over one orbit. However this has been found to be acceptable, particularly in applications where maximizing imaging time per orbit is a less important criterion than, for example, minimizing the time between repeated images of a particular area on Earth. There is therefore also provided a method of operating a satellite as described here to limit the ON time of the radar antenna array to avoid overheating. This can be achieved by limiting the total ON time during a single image acquisition or by limiting the total ON time during a single orbit, or both. The control of the ON time may be from the ground segment or programmed into the satellites onboard computer. A suitable maximum may be determined through experimentation. In an example, an alert limit is set such that imaging is turned off if the antenna array exceeds a maximum of 45 degrees c, even though individual parts in the antenna array may be rated for 80 degrees c or more. The alert limit is well short of the maximum capability of the components to improve reliability.

Similarly, a lower limit can be set such that imaging does not occur when the temperature of the antenna array falls below −25 degrees c, even though the individual parts of the antenna array may be rated for down to −40 degrees C. For an Earth-monitoring satellite in low earth orbit the time taken to complete an orbit around Earth may be around 90 minutes. In an example, 75 seconds of imaging per orbit can be achieved within the thermal constraints. A suitable maximum imaging time, i.e., image data acquisition time during a single orbit, is 180s, and a suitable maximum designed single image duration is 120s. In other words, with suitable limitation on the time the payload is on, a small satellite may be passively thermally managed and no dedicated cooling equipment is required. According to some examples, the limitation may be around 3%, e.g. 2-4%, of the orbit duration, i.e. the time taken for the satellite to travel the circumference of Earth. However, higher limits may be possible with more thermal management capability.

The heat sink elements such as heatsink plate 513 and support structure 516 may act as a buffer, storing heat to be radiated away at a later time. The amount of imaging time in an orbit is limited by how fast the heat can be radiated out from the antenna so larger heat sinks and possibly more radiative surfaces could help with increasing the imaging time.

Imaging may take place in different modes and the effective imaging time may differ according to the imaging mode. For example, the maximum time for continuous imaging will usually be lower than the maximum time in another imaging mode during which the radar antenna array is turned on and off during different periods of time in the orbit. Turning the antenna off between imaging within an orbit allows the antenna to cool down somewhat so it can image for a longer total time.

In the designs discussed here the heat is not conducted back to the bus and radiated out from the emitter, although this possibility is not excluded. In the designs discussed here the bus 110 and the radar antenna array are thermally isolated from each other.

Although a typical time for a satellite in a low earth orbit to complete a circuit of Earth is 90 minutes, it does not necessarily mean that the satellite can repeatedly image a particular spot on Earth every 90 minutes. Typically, a satellite does not continue in the same circular orbit around the earth but follows a more complex orbital pattern so that it does not reappear over the same spot every 90 minutes or so. This may be undesirable for continuously monitoring locations on Earth. However, the orbital pattern of a single satellite may be designed so that the satellite is able to image the same location on earth approximately once per day. Further, by operating multiple satellites in a constellation a spot on Earth may be imaged by more than one satellite to provide for more frequent monitoring of particular locations. In an example, repeat time of 24 hours or less, 12 hours or less, six hours or less, or even four hours or less may be achieved with a suitable constellation of small satellites. Small satellites according to the current disclosure are particularly suitable for applications where frequent revisit times to a particular location on Earth are required, and where the amount of imaging that can be done over the course of an entire orbit is less important. Their lower cost also makes them particularly suitable for deploying in large constellations of satellites to allow for shorter repeat cycles, for example with five or more satellites, 10 or more satellites, 15 or more satellites, or 25 or more satellites.

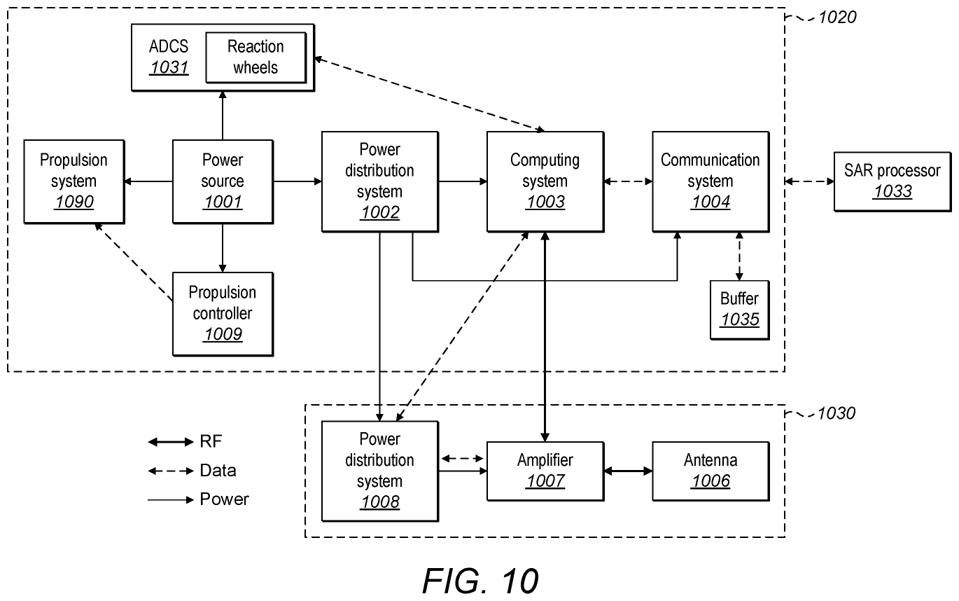

FIG. 10 is a schematic diagram illustrating a possible arrangement of satellite electronics components for any of the satellite designs described here. One-directional solid arrows between components are used to indicate power connections, two-directional solid arrows are used to indicate RF signal connections, and dotted lines are used to indicate data connections.

In the arrangement of FIG. 10, some components are located at the satellite bus, indicated by rectangle 1020, and some are located at the radar antenna array indicated by rectangle 1030. The arrangement shown in FIG. 10 comprises a power source 1001 and a power distribution system 1002. The power source 1001 may comprise the solar panels and batteries described above. The power distribution system 1002 supplies power to a propulsion system 1090 for example comprising thrusters 195, propulsion controller 1009, attitude determination and control system “ADCS” 1031 which may comprise the ADCS 190 of FIG. 1, computing system 1003, buffer 1035, and a communication system 1004, which may comprise the downlink antenna 210. The buffer 1035, although shown as a separate item, may be comprised in the computing system 1003 and may comprise the mass, e.g. flash, memory 404 mentioned above.

The propulsion controller 1009 is shown here as a separate item but in practice it may form part of the computing system 1003. The propulsion controller may be configured to control the propulsion system 1090, either through the use of control software implemented in one or more processors comprised in the propulsion controller 1009 or on in response to received instructions, for example from the computing system. Where the instructions are transmitted from the computing system 1003, the computing system may be considered to comprise a propulsion controller. One of the functions of the propulsion controller 1009 may be to output control signals to ion sources and electron sources of thrusters in the propulsion system 1090.

As described with reference to FIG. 5, the radar antenna array 160 shown in FIG. 6 comprises a plurality of modules each comprising an RF board 512 on which amplifiers are mounted, a power board 514 on which power components are mounted and an antenna board supporting antenna elements as shown in FIG. 7. Each RF board comprises multiple front ends. In FIG. 10 these components are represented collectively as single blocks for simplicity. Thus, antenna block 1006 represents the plurality of antenna elements of all modules, amplifier block 1007 represents the plurality of RF front ends for example comprised in the radar antenna array 160 and power distribution system block 1008 represents the plurality of power distribution components for multiple modules comprised in the radar antenna array 160. Both power distribution systems 1002 and 1008 may comprise control logic as is known in the art.

The antennas 1006 together with amplifiers 1007 and power distribution system 1008 collectively form image acquisition apparatus of the satellite, as is known to those skilled in the art. They may perform functions other than the acquisition of image data.

The amplifier block 1007 has a two-way data communication link with the computing system 1003, in the illustrated example via the power distribution system 1008 and may be configured to send data to the computing system 1003 such as data relating to received radar signals. The data may be processed by the communication system 1003, for example to generate images, which may then be output to the communication system 1004 for onward transmission. In the system illustrated in FIG. 10, raw data is output by the computing system 1003 to the communication system 1004 for processing by a remote computing system. In FIG. 10, a SAR processor 1033 may be located at a ground station, for example, or in another processing location.

Raw SAR data may be stored in the satellite in memory, for example buffer 1035. In an example, 30 seconds of imagery can be stored at full resolution (bandwidth). More can be stored at lower resolution (e.g., 60 seconds at half resolution). In an example, a small satellite may have a 150 MBs download link. At this data rate it takes about 3 minutes to download the 30 seconds of full resolution imagery data.

During operation, for example during spotlight mode, around 5000 pulses per second may be transmitted. This means that 27 pulses might be in the air at any given time.

The communication system 1004 may communicate with earth stations or other satellites using radio frequency communication, light, e.g., laser communication, or any other form of communication as is known in the art.

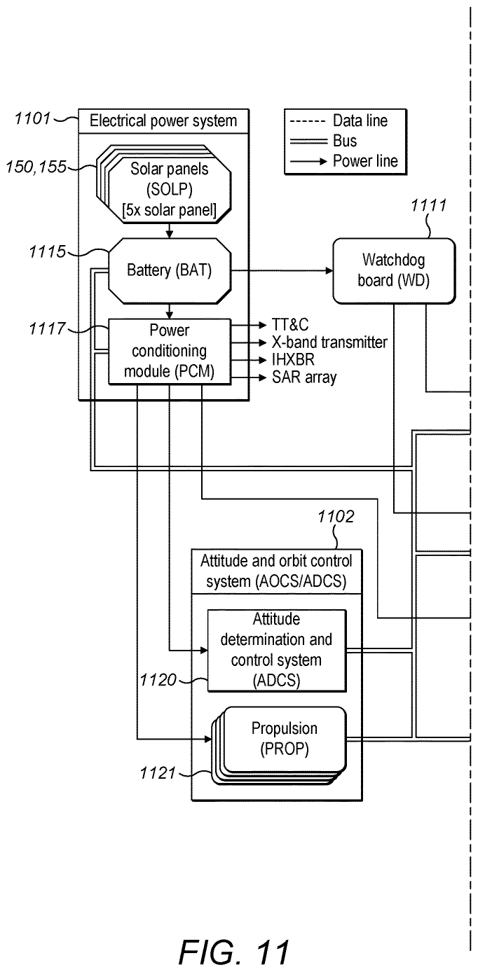

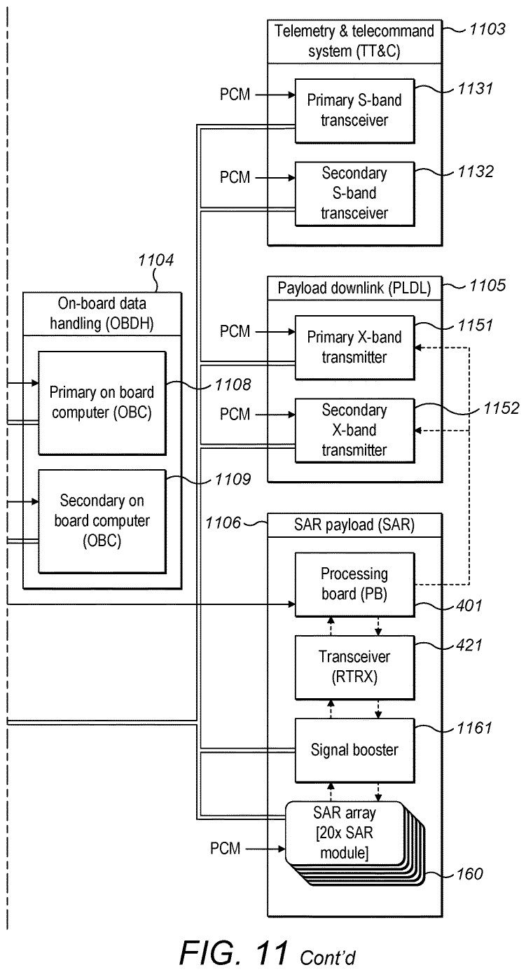

FIG. 11 shows a possible configuration of the components shown in FIG. 10. Here double lines indicate two-way bus connections between components, arrows with solid lines indicate power connections and arrows with dashed lines indicate data connections. The configuration comprises generally an electrical power system 1101, attitude and orbit determination control system “ADCS/AOCS” 1102, telemetry and telecommand system 1103, onboard data handling 1104, payload downlink 1105 and SAR payload 1106.

On board data handling may be performed by an onboard computer. FIG. 11 shows primary and secondary on-board computers 1108, 1109 for this purpose, which may share tasks and/or provide redundancy one for another. The on board computers may be used to restrict the acquisition of image data for the purposes of thermal management, as described elsewhere here.

A watchdog board 1111 may be provided for example comprising circuitry to protect the onboard computers 1108, 1109 against power failures, as is known in the art.

The electrical power system 1101 comprises the solar panels 150, 155 described above, battery 1115, and power conditioning module 1117.

The ADCS/AOCS 1102 comprises ADCS 1120 and propulsion controllers 1121 for controlling the satellite orbit. These may comprise separate computing devices that control components such as reaction wheels of an ADCS and thrusters of a propulsion system 1090 to control the satellite attitude and orbit respectively.

Telemetry and telecommand system 1103 may comprise primary and secondary S-band (2-4 GHZ) transceivers for communications between the satellite and a ground segment.

Payload downlink 1105 comprises primary and secondary X-band transmitters 1151 and 1152 for downloading of SAR payload data to a ground segment.

The SAR payload 1106 comprises processing board 401, transceiver 421, Signal booster 1161 and radar antenna array 160 comprising 20 SAR modules. The Signal booster 1161 provides power and control signals to the divider board, as well as boosting the signal for the SAR array.

Any of the computers or computing systems described here may be a conventional computing system as is known in the art and may include one or more controllers such as, for example, a central processing unit processor (CPU), a chip or any suitable processor or computing or computational device, an operating system, a memory, and storage. One or more processors in one or more controllers may be configured to cause the satellite to operate as described in the foregoing. For example, one or more processors within a controller may be connected to memory storing software or instructions that, when executed by the one or more processors, cause the one or more processors to operate the satellite.

The functions performed by computers and computing systems described here may be distributed in any suitable manner and do not necessarily require dedicated computers. Thus, for example one computer or computing system may perform some functions of ADCS and AOCS in addition to onboard data handling.

Some operations of the methods described herein may be performed by software in machine readable form e.g., in the form of a computer program comprising computer program code, in some instances at a ground station. Thus, some aspects of the invention provide a computer readable medium which when implemented in a computing system cause the system to perform some or all of the operations of any of the methods described herein. The computer readable medium may be in transitory or tangible (or non-transitory) form such as storage media include disks, thumb drives, memory cards etc. The software can be suitable for execution on a parallel processor or a serial processor such that the method steps may be carried out in any suitable order, or simultaneously.

It will be understood that the benefits and advantages described above may relate to one embodiment or may relate to several embodiments. The embodiments are not limited to those that solve any or all of the stated problems or those that have any or all of the stated benefits and advantages.

Any reference to “an” item or “piece” refers to one or more of those items unless otherwise stated. The term “comprising” is used herein to mean including the method steps or elements identified, but that such steps or elements do not comprise an exclusive list and a method or apparatus may contain additional steps or elements.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

The order of the steps of the methods described herein is exemplary, but the steps may be carried out in any suitable order, or simultaneously where appropriate. Additionally, steps may be added or substituted in, or individual steps may be deleted from any of the methods without departing from the scope of the subject matter described herein. Aspects of any of the examples described above may be combined with aspects of any of the other examples described to form further examples.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1. A satellite for operation in orbit around Earth comprising:
a propulsion system;
an attitude determination and control system “ADCS”; and
an earth observation system for imaging a surface of Earth, the earth observation system comprising a Synthetic Aperture Radar “SAR” phased array antenna;
wherein
the SAR phased array antenna is formed as a generally planar structure comprising a plurality of panels, each panel comprising a plurality of antenna transmit/receive modules, each antenna transmit/receive module comprising a stack of planar elements, the stack of planar elements comprising:
an RF board supporting a plurality of RF front ends;
an antenna board;
a power board; and
a heatsink board for conducting heat from the RF board, the heatsink board being sandwiched between the power board and the RF board so that adjacent major surfaces of the heatsink board, the power board and the RF board are in contact.

2. The satellite of claim 1 wherein each RF board comprises between 8 and 32 RF front ends.

3. The satellite of claim 1 wherein each RF front end comprises a power amplifier, a transmit/receive switch and a low noise amplifier.

4. The satellite of claim 1 configured for operation of the SAR phased array antenna as a phased array.

5. The satellite of claim 1 wherein each RF front end comprises a digital phase shifter in each of a transmit direction and a receive direction.

6. The satellite of claim 1 wherein the antenna board supports an array of antenna elements, wherein the antenna elements comprise patch antenna elements and wherein each RF front end is configured to drive a plurality of antenna elements.

7. (canceled)

8. (canceled)

9. The satellite of claim 1 wherein the SAR phased array antenna comprises a row of panels with adjacent panels being pivotable with respect to each other whereby the array may be folded for transport and deployed in space.

10. (canceled)

11. (canceled)

12. (canceled)

13. The satellite of claim 1 comprising an array of solar panels in a fixed relationship to the SAR phased array antenna.

14. The satellite of claim 13 wherein the solar panels of the array of solar panels are arranged in a generally planar arrangement extending in two opposing directions parallel to the extending directions of the SAR phased array antenna with a plane of the solar panels perpendicular to the plane of the plane of the radar array.

15. The satellite of claim 13 wherein the solar panels of the array of solar panels are arranged with adjacent panels being pivotable with respect to each other to enable the solar panel array to be folded for transport and deployed in space.

16. The satellite of claim 1 comprising a mass memory for storage of data acquired by the SAR phased array antenna and a transmitter directly connected to the mass memory for downloading of the data.

17. (canceled)

18. (canceled)

19. (canceled)

20. The satellite of claim 1 wherein the heatsink board comprises one or more structures arranged to conduct heat away from the RF board to the antenna board.

21. The satellite of claim 1 configured for operation of the SAR phased array antenna at wavelengths between 4-12 GHz, optionally between 8-12 GHz or between 4-8 Ghz.

22. The satellite of claim 1 configured for operation of the SAR phased array antenna as a synthetic aperture radar.

23. The satellite of claim 1 wherein the ADCS is configured for rotating the satellite about an axis parallel to a direction of travel along an orbit.

24. The satellite of claim 1 wherein an average transmitted power is greater than 200 W per metre square during imaging.

25.-30. (canceled)

31. The satellite of claim 1 wherein a peak transmitted power is in a range of 1000 to 5000 W per meter square or an average transmitted power is in the range of 200-1000 W per meter square.

32. A method of operating a satellite for obtaining image data, the satellite being for operation in orbit around Earth and comprising:
a propulsion system;
an attitude determination and control system “ADCS”; and
an earth observation system for imaging a surface of Earth, the earth observation system comprising a Synthetic Aperture Radar “SAR” phased array antenna;
wherein the SAR phased array antenna is formed as a generally planar structure comprising a plurality of panels, each panel comprising a plurality of antenna transmit/receive modules, each antenna transmit/receive module comprising a stack of planar elements, the stack of planar elements comprising:
an RF board supporting a plurality of RF front ends;
an antenna board;
a power board; and
a heatsink board for conducting heat from the RF board, the heatsink board being sandwiched between the power board and the RF board so that adjacent major surfaces of the heatsink board, the power board and the RF board are in contact;
the method comprising limiting a time per orbit during which the SAR phased array antenna is switched on to avoid overheating of the SAR phased array antenna.

33. The method of claim 32, further comprising: restricting an acquisition of image data to 3% of a duration of the satellite orbit.

34. A satellite SAR phased array antenna for imaging a surface of Earth formed as a generally planar structure comprising a plurality of panels, wherein: each panel comprises a plurality of antenna transmit/receive modules, each antenna transmit/receive module comprising a stack of planar elements, the stack of planar elements comprising:
an RF board supporting a plurality of RF front ends;
an antenna board;
a power board; and
a heatsink board for conducting heat from the RF board, the heatsink board being sandwiched between the power board and the RF board so that adjacent major surfaces of the heatsink board, the power board and the RF board are in contact.
